(19) United States
(12) Patent Application Publication
(10) Pub. No.: US 2014/0375214 A1
(43) Pub. Date: Dec. 25, 2014

(54) SYSTEMS AND METHODS FOR CONSTANT ILLUMINATION AND COLOR CONTROL OF LIGHT EMISSION DIODES IN A POLYPHASE SYSTEM

(71) Applicant: 3M INNOVATIVE PROPERTIES COMPANY, St. Paul, MN (US)

(72) Inventor: Martin J. Vos, St. Paul, MN (US)

(21) Appl. No.: 14/374,470

(22) PCT Filed: Mar. 5, 2013
(86) PCT No.: PCT/US2013/029082

§ 371 Date: Jul. 24, 2014

Related U.S. Application Data
(60) Provisional application No. 61/610,713, filed on Mar. 14, 2012.

(51) Int. Cl. H05B 33/08; H05B 37/02

(52) U.S. Cl. CPC H05B 33/0815; H05B 33/0845; H05B 33/0857; H05B 33/083; H05B 37/029
USPC 315/122

(57) ABSTRACT

In one aspect, a light emission diode (LED) illumination system is capable of providing generally constant illumination by LED ladders coupled to power sources in a polyphase system, where each LED ladder is coupled to a power source respectively. In another aspect, a colored LED illumination system includes multi-color LEDs and is capable of controlling the color output from the LEDs. The colored LED illumination system includes a plurality of LED ladders coupled to a color-mix-control circuit. The color-mix-control circuit can control the output color of the LED ladders by adjusting the intensity of each LED ladder individually.

### BACKGROUND

Light emitting diodes (LEDs) typically have low forward drive voltages and can be driven by a DC power supply. For example, LEDs in a cellular phone are powered by a battery. A string of multiple LEDs in series can also be directly AC driven from a standard AC line power source. For example, Christmas tree LED lights are a string of LEDs connected in series so that the forward voltage on each LED falls within an acceptable voltage range. Alternatively, a string of LEDs can be driven by a DC power source, which requires conversion electronics to convert a standard AC power source into DC current.

A polyphase system is a means of distributing alternating current electrical power. Polyphase systems have three or more power sources providing alternating currents with a definite time offset between the voltage waves in each phase. The most common example is the three-phase power system used for industrial applications and for power transmission. Three-phase electronic power systems have voltage waveforms that are 27π/3 radians (120°, ⅓ of a cycle) offset in time. A single-phase load may be powered from a three-phase distribution system either by connection between a phase and neutral or by connecting the load between two phases. The load device must be designed for the voltage in each case. Illumination devices are often powered by a single phase load where the voltage is changing over time.

### SUMMARY

At least one aspect of the present disclosure features a circuit for producing generally constant illumination from light emitting diodes (LEDs) in a polyphase system having three or more power sources providing alternating currents. The circuit includes three or more LED ladders, each LED ladder coupled to one of the three or more power sources on a one-to-one basis. Each LED ladder includes a plurality of light sections connected in series. The three or more power sources collectively provide substantially constant electrical power. Each light section comprises an LED and a switch circuit coupled to the LED and configured to activate the LED. At least two light sections are activated in sequence in response to power supplied from the one of three or more power sources.

At least one aspect of the present disclosure features a circuit for controlling an output color of a light emitting diode illumination system coupled to a polyphase system having three or more power sources providing alternating currents. The circuit includes a plurality of LED ladders and a color-mix-control circuit. Each LED ladder is coupled to one of the three or more power sources and includes a plurality of light sections connected in series. Each light section includes a color LED and a switch circuit coupled to the color LED and configured to activate the color LED. At least two light sections are activated in sequence in response to power supplied from the one of the three or more power sources. Color LEDs in the plurality of LED ladders emit light of different colors. The color-mix-control circuit is coupled to the plurality of LED ladders and configured to adjust the intensity of each LED ladder to control an output color of the plurality of LED ladders.

### BRIEF DESCRIPTION OF THE DRAWINGS

The accompanying drawings are incorporated in and constitute a part of this specification and, together with the description, explain the advantages and principles of the invention. In the drawings,

FIG. 1A illustrates the phase power and total power of a three-phase system;

FIG. 1B illustrates the relationship between the power supply and the illumination output of an LED ladder;

FIG. 2 illustrates a block diagram an embodiment of an LED illumination system;

FIG. 3A illustrates a block diagram of an embodiment of an LED ladder;

FIG. 3B illustrates a block diagram of another embodiment of an LED ladder;

FIG. 4A is an illustrative circuit diagram of an exemplary LED ladder;

FIG. 4B is another illustrative circuit diagram of a LED ladder;

FIG. 5A is a graph of approximating the gate-source voltage versus drain current characteristic for a depletion mode transistor;

FIG. 5B illustrates a graph of resistor ratio Wₙ/Bₙ versus light section number;

FIG. 6 illustrates a block diagram of an embodiment of a colored LED illumination system;

FIG. 7 illustrates an exemplary circuit diagram of an embodiment of a colored LED illumination system;

FIG. 8 is a graph illustrating current and voltage profiles of an 11 section LED ladder driver; and

FIG. 9 is a graph illustrating a current spectrum of a LED ladder driver having harmonic distortion within the IEC limits, corresponding to the current profile in FIG. 8.

### DETAILED DESCRIPTION

A polyphase system is commonly used to distribute electrical power with alternating current. The computation below shows that the total power carried by the power sources in a balanced polyphase system is a constant. At least one aspect of the present disclosure is directed to light emitting diode (LED) illumination systems, where each of the power sources in the polyphase system is coupled to a LED ladder such that the LED ladders collectively produce generally constant illumination. As used herein, an LED ladder refers to a plurality of LEDs connected in series with a driver circuit. Another aspect of the present disclosure is directed to colored LED illumination systems providing a controllable color by one or more LED ladders with various colors coupled to the power sources in the polyphase system. In some embodiments, the colored LED illumination systems includes a color-mix-control circuit coupled to the one or more LED ladders to generate a desirable output color by controlling the intensity of each LED ladder. As used herein, intensity of an LED ladder refers primary to the number of activated LEDs in the LED ladder.

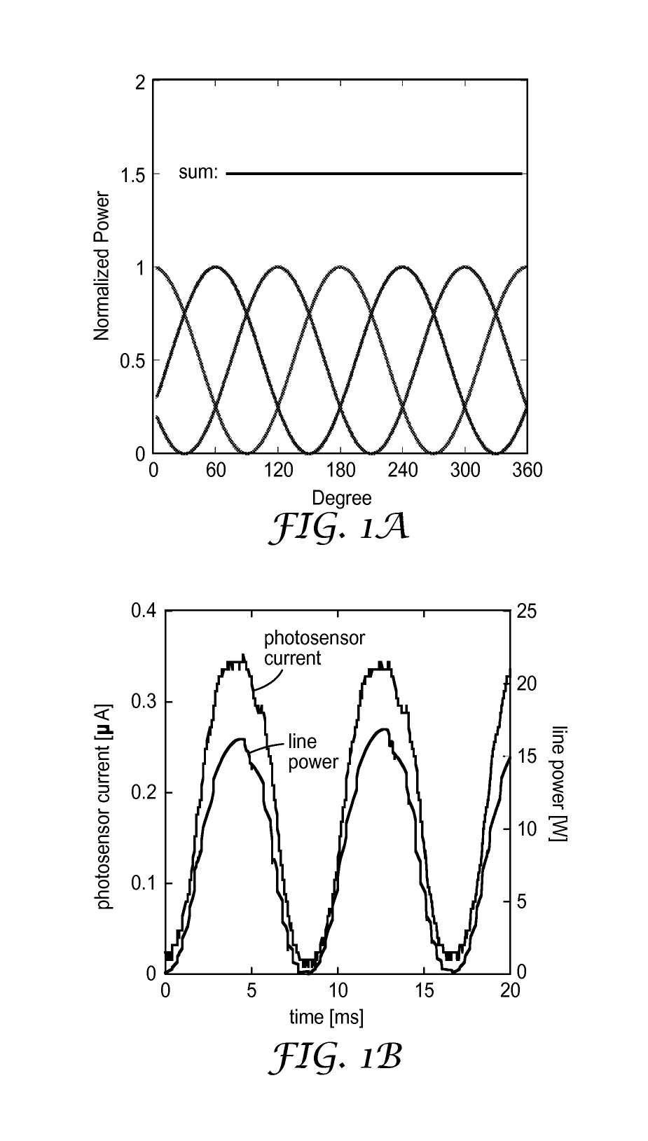

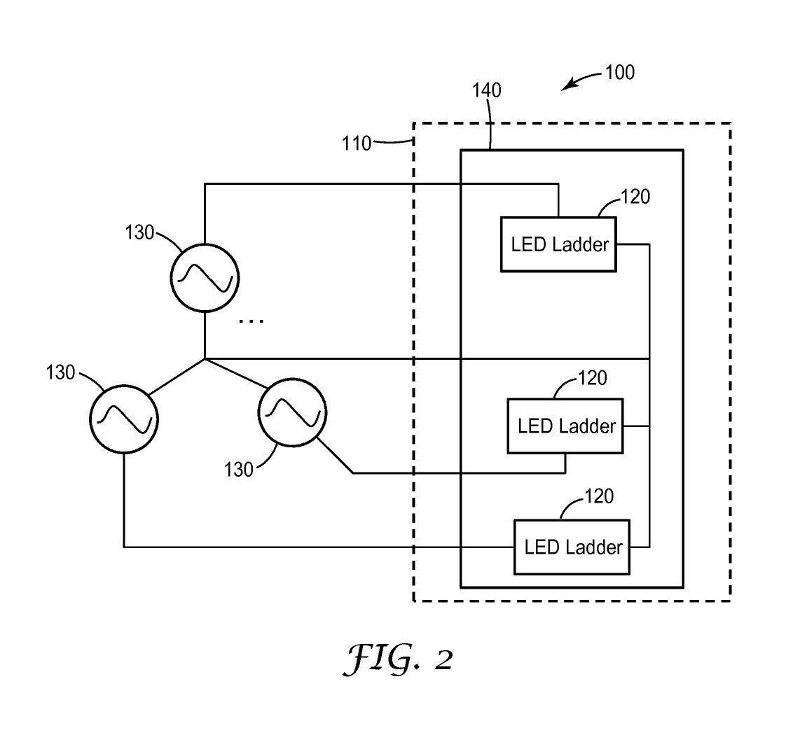

The total normalized power p in a resistive and balanced M-order polyphase system is of a cosine squared form with t=0 chosen and is given by equation (1) showing that for order M≧3, the normalized power p is time independent. FIG. 1A illustrates the power of each phase load and the total power of a three-phase system conforming to the above computation.

Illumination output for an LED ladder is generally proportional to the electrical phase power supplied, as illustrated in FIG. 1B, where the illumination output is measured in photosensor current. This near perfect harmonic dependence can be used advantageously in a balanced polyphase power supply system in predominantly industrial or commercial settings, for example, a three-phase power supply system. Thus, in the embodiments of LED illumination systems, where each of the power sources in the polyphase system is coupled to a LED ladder, the luminous flux output from the LED ladders are summed to a time-independent value.

$$\begin{matrix}p = {\sum }_{m = 1}^{M} {cos}^{2} ( ω t + \frac{m 2 π}{M} ) \\ = {\sum }_{m = 1}^{M} {( cos ω t cos \frac{m 2 π}{M} - sin ω t sin \frac{m 2 π}{M} )}^{2} \\ = {cos}^{2} ω t ( \frac{M}{2} + \frac{cos \frac{2 π ( M + 1 )}{M} sin 2 π}{2 sin \frac{2 π}{M}} ) + \\ {sin}^{2} ω t ( \frac{M}{2} - \frac{cos \frac{2 π ( M + 1 )}{M} sin 2 π}{2 sin \frac{2 π}{M}} ) - \\ \frac{1}{2} sin 2 ω t \frac{sin \frac{2 π ( M + 1 )}{M} sin 2 π}{sin \frac{2 π}{M}} \\ = \frac{M}{2} ∀ M \geq 3\end{matrix} \qquad ( 1 )$$

To better understand this disclosure, FIG. 2 illustrates an embodiment of an LED illumination system 100. In the illumination system 100, an LED illumination circuit 110 for producing generally constant illumination from LEDs is coupled to power sources 130 in a polyphase system. The polyphase system has three or more power sources 130 providing alternating currents. The polyphase system is shown in Y-configuration but could also be connected in Δ-configuration. The circuit 110 includes three or more LED ladders 120. Each LED ladder 120 is coupled to one of the three or more power sources 130 on a one-to-one basis. As used herein, a one-to-one basis refers to a pairing of each member of a group uniquely with a member of another group. The illumination circuit 110 can optionally include an optical mixing cavity 140, which contains LEDs in the three or more LED ladders 120. In some cases, the optical mixing cavity 140 can be implemented with various optical components to provide intra-cavity optical mixing and then produce substantially uniform illumination output. The optical components can include one or more of, for example, such as diffusers, reflectors, transflectors, polarizing films, brightness enhancement films (BEF), or the like.

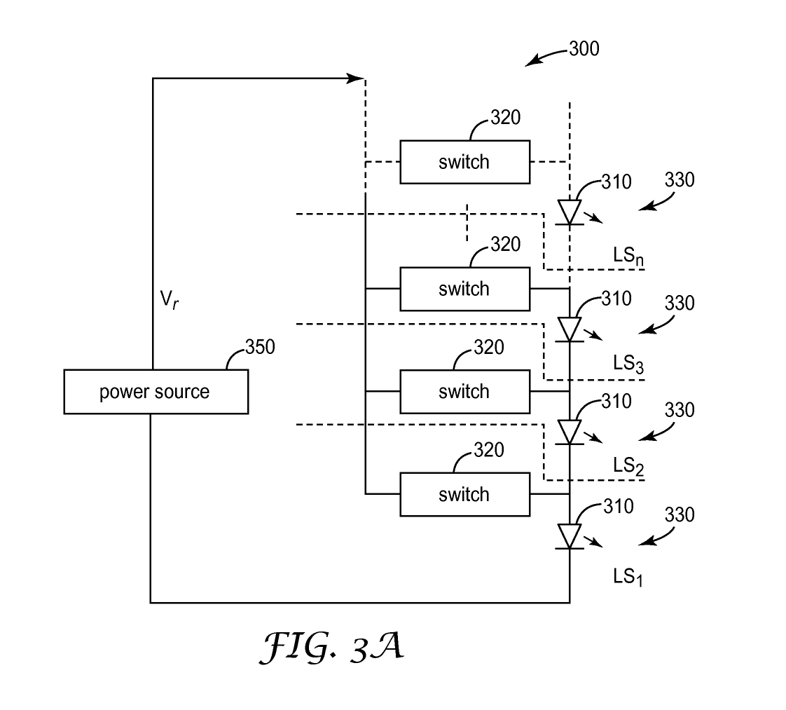

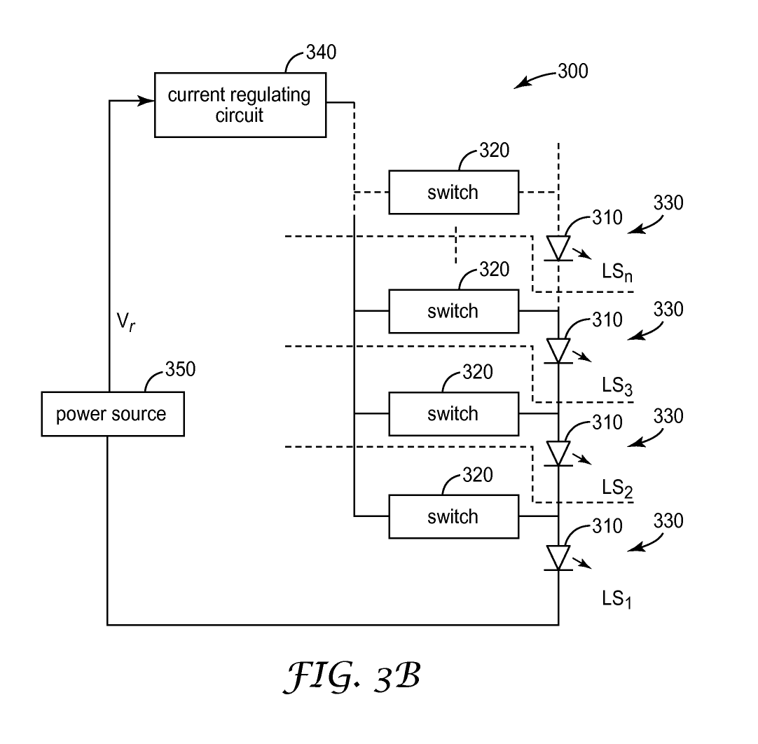

FIG. 3A illustrates a block diagram of an embodiment of an LED ladder 300. In some embodiments, the LED ladder 300 includes a plurality of light sections 330 (i.e., light sections LS₁ to LSₙ) connected in series and configured to connect to a power source 350, such as one of the three or more power sources in a polyphase system. Each light section 330 includes an LED 310 and a switch circuit 320 (typically not included in the highest light section) coupled to the LED and configured to activate the LED 310. The LED 310, also referred to as an ‘LED device’, comprises one or more LED junctions, where each LED junction can be implemented with any type of LED of any color emission but with preferably the same current rating. In some embodiments, the LED junctions are connected in series. Multiple LED junctions can be contained in a single LED housing or among several LED housings. For example, the LED device 310 may comprise six LED junctions within one LED housing. The light sections are activated in sequence from low to high (i.e., from LS₁ to LSₙ) in response to power supplied from the power source 350.

The switch circuit 320 is normally closed or conducting. When the power source 350 increases its output Vᵣ over a predetermined threshold, the switch circuit 320 of a light section n is opened or non-conducting. The switch circuits of lower light sections i (i<n) are opened or non-conducting. In such implementation a LED current flows through the LEDs in the light sections from the first light section to the light section n+1 and these LEDs become illuminated. The predetermined threshold can be determined by the switch circuit design. The switch circuit 320 may include one or more transistors. In some implementations, the switch circuit 320 may include a depletion mode transistor. The switch circuit 320 may include one or more resistive elements, for example, such as resistors. In some implementations, the switch circuit 320 may include a variable resistive element, which can be adjusted to fine tune the predetermined threshold relative to the output Vᵣ of the power source 350.

In some embodiments, an LED ladder may include an optional circuit regulating current flowing through LEDs to minimize harmonic distortion, as illustrated in FIG. 3B. In such embodiments, the LED ladder 300 can include a current regulating circuit 340. The current regulating circuit 340 is configured to limit a LED current flowing through the plurality of light sections based upon the number of activated light sections. The current regulating circuit 340 may include a depletion mode transistor, a MOSFET, a high power MOSFET, or other components. In such embodiments, the LED ladder allows driving multiple LEDs in series in AC line applications with minimal harmonic distortion in drive current and near unity power factor. The LED ladder circuits are designed to be converted to integrated circuits (ICs) such that the costs of the circuits are reduced for large quantity manufacturing. In some embodiments, the driver circuits do not have inductor and capacitor elements that are not feasible components to be fabricated onto an IC chip. In some other embodiments, the LED ladder circuits comprise only fixed value components, such as fixed value resistors, which reduce manufacturing complexity and cost. The circuits also allow direct dimming as well as color variation with a dimmer circuit, for example, a conventional TRIAC dimmer. Furthermore, the circuitry has line voltage surge protection capability and a relative insensitivity to undervoltage operation. Such circuits can provide the benefits of high efficiency and low cost.

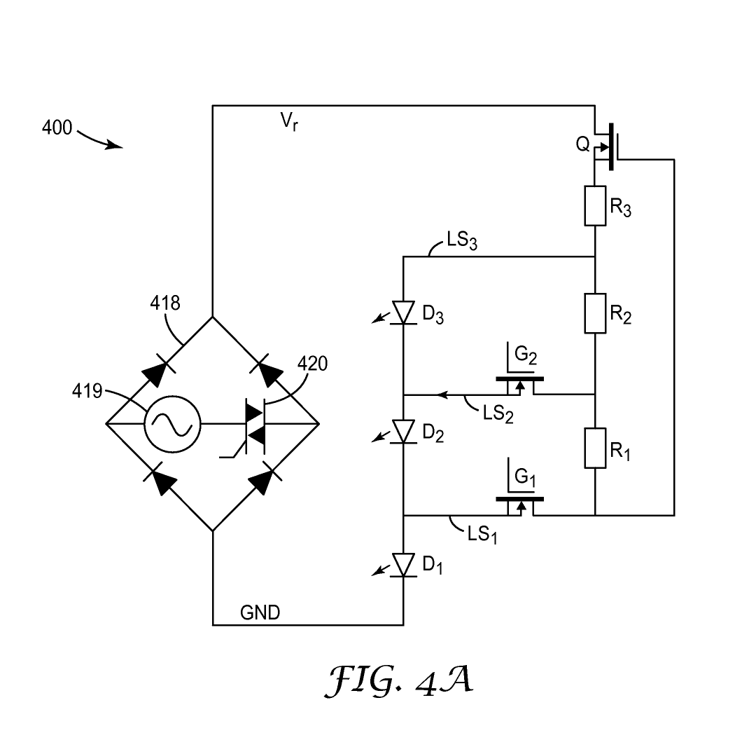

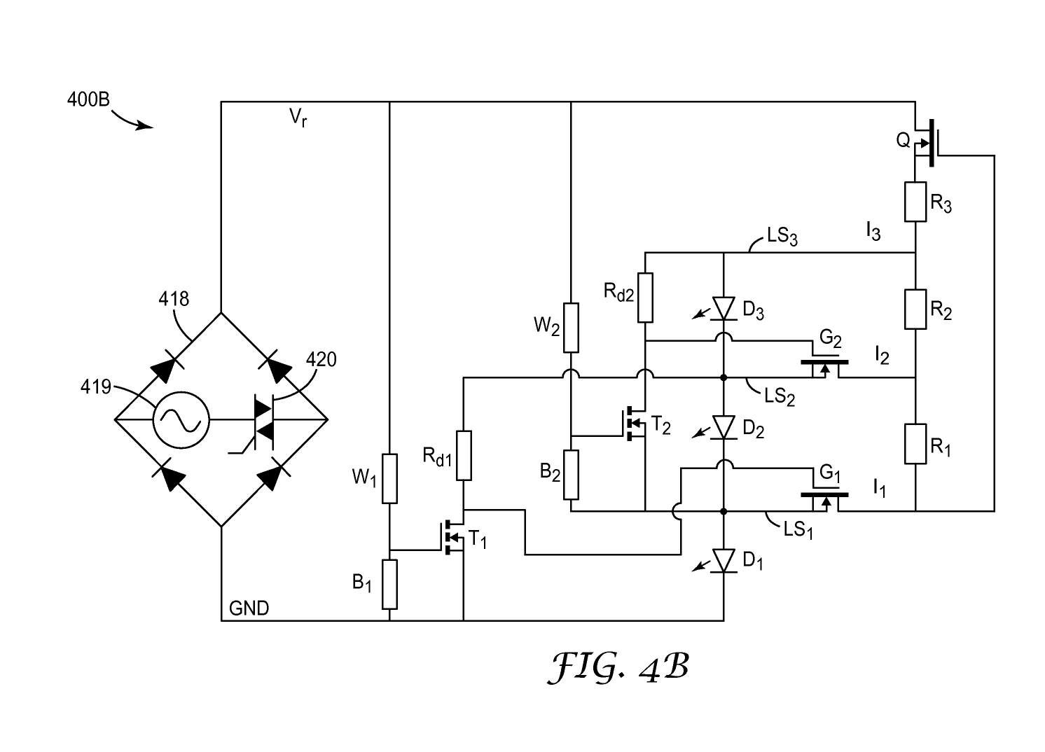

FIG. 4A is an illustrative circuit diagram of an LED ladder circuit 400 with current regulation for driving a plurality of LEDs connected in series. Circuit 400 includes a series of three (N=3) light sections LS₁, LS₂, and LS₃ connected in series and a depletion mode transistor Q for regulating LED current. Each light section n (1≦n≦N) controls Lₙ LED junctions. The first section LS₁ includes LED junctions D₁ depicted as one diode, a resistor R₁, and a transistor G₁ functioning as a switch circuit. The second section LS₂ includes LED junctions D₂ depicted as one diode, a resistor R₂, and a transistor G₂. The third section LS₃ (i.e., the highest light section in the illustrative circuit diagram in FIG. 4A) includes LED junctions D₃ depicted as one diode and a resistor R₃. In some implementations, when a light section n is activated, a large negative gate-source voltage for G transistors in the lower light sections (i.e., light sections i, where i<n) can be obtained such that cut-off is more effective by properly biasing the gate voltage of the G transistors in these lower light sections. As used herein, cut-off refers to G transistors having relatively low drain source current such that the G transistors function close to a switch. In some implementations, the G transistors can have negligible drain source current such that the G transistors function close to a perfect switch (i.e., with open state with current as 0 A). In such implementations, the highest light section does not have a G transistor as it typically will not be cut off. Switch transistors G₁ and G₂ can each be implemented by a depletion MOSFET. Current limiting transistor Q can also be implemented by a depletion MOSFET. The light sections form a ladder network in order to activate the LEDs in sequence from the first section (LS₁) to the last section (LS₃) in FIG. 4A.

The light sections LS₁, LS₂, and LS₃ are connected to a rectifier circuit 418 including an AC power source 419 (i.e., one of the three or more power sources in a polyphase system) and a dimmer circuit 420. In FIG. 4A, the dimmer circuit 420 is depicted as a TRIAC but can also be based on other phase cutting electronic components. In some configurations, the dimmer circuit can include an autotransformer (i.e., a variac) or a switched-mode power supply electronic component. In a practical 277 V rms or 390 V peak case there are preferably more than three sections, possibly twenty to forty sections to bring the section voltage into a range of 10 to 20 volt.

In FIG. 4A, only three light sections are shown, but the ladder can be extended to any N light sections with a number of Lₙ LED junctions for a light section n that is consistent with the maximum Vᵣ drive voltage where the total number of LED junctions is given by the summation of

$${\sum }_{n = 1}^{N} {L}_{n} .$$

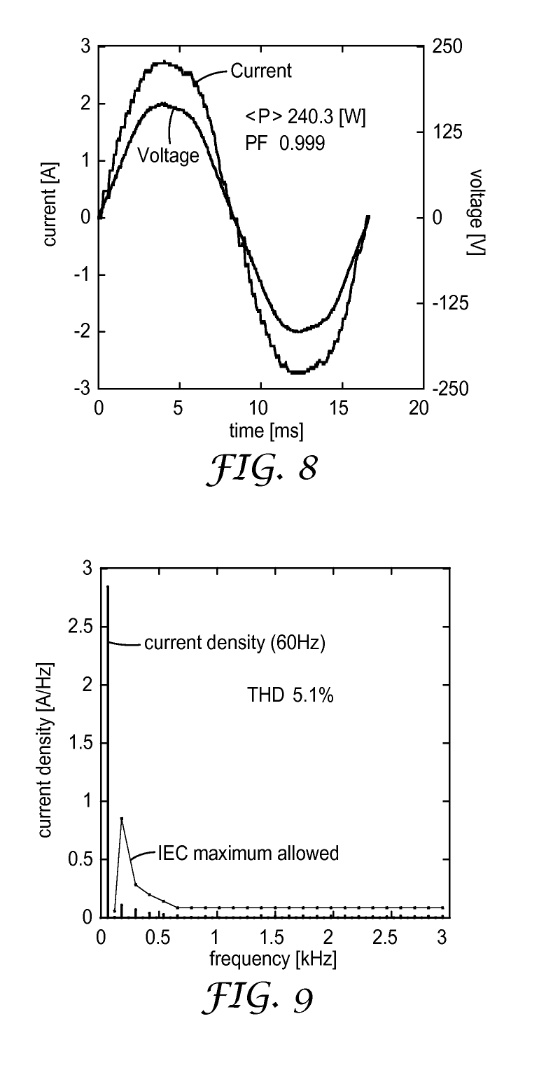

Also, each light section can contain more than one LED junction. In some cases, each light section contains at least three LED junctions. Multiple LED junctions can be contained in a single LED component or among several LED components. The transistor Q limits the LED current flowing through the light sections. These current limits are visible as small plateaus in FIG. 8. The Q transistor usually does not require a high voltage rating. Its gate-source voltage is typically limited because for higher Vᵣ values more light sections will become currentless resulting in no voltage drop over the lower Rₙ resistors.

During extreme line power consumption, an undervoltage situation can occur that may lead to one or more upper LED sections not being illuminated. The other sections however remain illuminated at their rated currents so that undervoltage situations have a limited effect on the total light output.

With <P> the time averaged consumed phase power in a system with peak phase voltage Vₚₑₐₖ, the maximum or peak phase current Iₘₐₓ is approximately given by:

$${I}_{ma x} \approx \frac{2 〈 P 〉}{{V}_{peak}} \qquad ( 2 )$$

In the FIG. 4A arrangement, the current limit Iₙ of a light section LSₙ is determined by that Q gate-source voltage V_{GS} imposing Iₙ through feedback with the sum of resistors Rₙ, as shown in equation (3). Assuming that the current intervals are equally spaced:

$${I}_{n} = \frac{{nI}_{ma x}}{N} = \frac{- {V}_{GS}}{{\sum }_{i = 0}^{N - n} {R}_{N - i}} \qquad ( 3 )$$

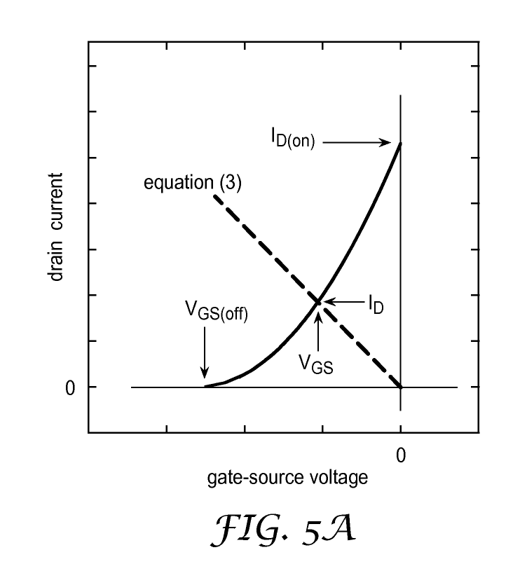

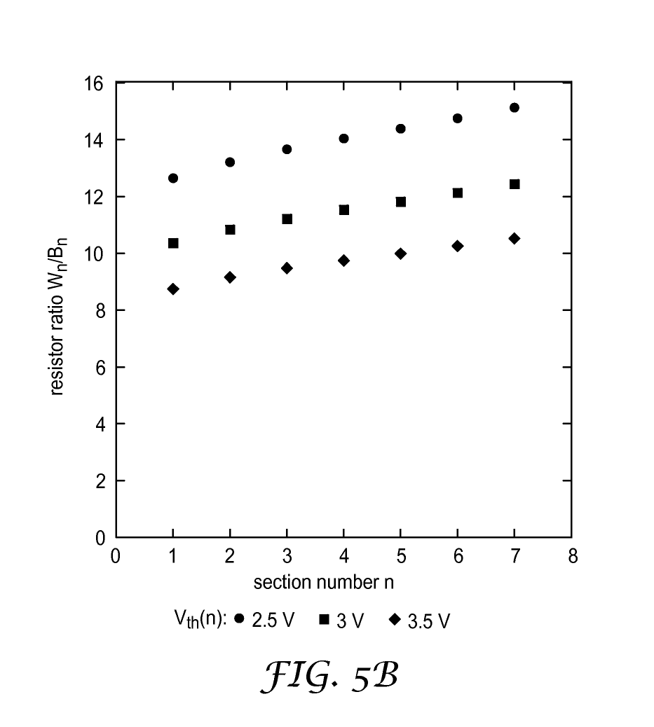

Referring to FIG. 5A that approximates the gate-source voltage versus drain current characteristic for a depletion mode transistor with a parabola:

$${I}_{D} = {{I}_{D ( on )} ( \frac{{V}_{GS}}{{G}_{GS ( off )}} - 1 )}^{2} . \qquad ( 4 )$$

which defines the parameters I_{D(on)} and V_{GS(off)}. Using these parameters and equation (3) leads to two equations for the section resistances Rₙ:

$$\begin{matrix}{R}_{N} = \frac{- {V}_{GS ( off )}}{{I}_{ma x}} \{ 1 - \sqrt{\frac{{I}_{ma x}}{{I}_{D ( on )}}} \} & ( 5 a ) \\ {R}_{n} = \frac{- {V}_{GS ( off )}}{{I}_{ma x}} \{ \frac{N}{n} - \frac{N}{n + 1} - \sqrt{\frac{{I}_{ma x}}{{I}_{D ( on )}}} ( \sqrt{\frac{N}{n}} - \sqrt{\frac{N}{n + 1}} ) \} \\ 1 \leq n < N & ( 5 b )\end{matrix}$$

Therefore, the resistance of the resistive element in a light section is a function of the peak phase current and the section number.

Referring back to FIG. 4A, the ladder network has dimming capability with dimmer circuit 420, which activates a selected number of light sections of the ladder. This selected lighted sections can include only the first section (LS₁), all sections (LS₁ to LS_{N}), or a selection from the first section (LS₁) to a section LSₙ where n<N. The dimmer circuit is configured to control the number of the light sections activated in sequence. The intensity of an LED ladder is controlled based upon how many light sections are active. In some embodiments, to achieve a generally constant illumination with multiple LED ladders with dimming, a dimmer circuit can be implemented by a circuit attenuating driving voltage and the dimmer circuit can control the intensity of the LED ladders simultaneously such that the intensity of each LED ladder is generally the same.

The ladder network also enables color control through use of the dimmer circuit 420. The color output collectively by the LEDs is determined by the dimmer circuit 420 controlling which light sections are active, the selected sequence of light sections, and the arrangement of LEDs in the light sections from the first light section to the last selected light section. As the light sections turn on in sequence, the arrangement of the LEDs determines the output color with colors 1, 2, . . . n correlated to the color of the LEDs in light sections LS₁, LS₂, . . . LSₙ. The output color is also based upon color mixing among active LEDs in the selected sequence of light sections in the ladder.

FIG. 4B is another illustrative circuit diagram of a LED ladder circuit 400B. The LED ladder circuit 400B includes a current regulation transistor Q, and for each light section n, a resistor Rₙ and a switch transistor Gₙ (except the highest light section N, which does not include a switch transistor) that are also included in the circuit 400 as illustrated in FIG. 4A. The circuit 400B includes additional resistors R_{dn}, Bₙ, Wₙ, and a transistor Tₙ for each light section n where 1≦n≦N to control the gate voltage of the switch transistors G.

When light section n's current Iₙ leading to a section voltage Vₙ=Lₙ·V_{LED}(Iₙ) is ready to be illuminated, then the rectified voltage Vᵣ must satisfy the following inequality:

Vᵣ>nVₙ 1≦n≦N (6)

with Lₙ the number of LED junctions in a light section LSₙ and V_{LED}(Iₙ) the V(I) curve for one LED junction.

For that greater value of Vᵣ=(n+1)Vₙ₊₁ and the already illuminated sections still drawing Iₙ, the gate-source threshold voltage Vₜₕ(n) of transistor Tₙ is approximately given by:

$${V}_{th} ( n ) \approx \frac{{B}_{n}}{{B}_{n} + {W}_{n}} [ ( n + 1 ) {V}_{n + 1} - ( n - 1 ) {V}_{n} ] , \\ where 1 \leq n \leq N - 1 \qquad ( 7 )$$

The approximation is a result of ignoring the voltage drop over G and Q and Q's effective source resistance. The value of the gate-source threshold voltage Vₜₕ(n) is interpreted as that gate-source voltage value leading to a Tₙ drain current that is sufficient to shut off Gₙ. Rearranging Equation (7) gives for the resistor ratio at the switching point Vᵣ=(n+1)Vₙ₊₁:

$$\frac{{W}_{n}}{{B}_{n}} \approx \frac{( n + 1 ) {V}_{n + 1} - ( n - 1 ) {V}_{n} - {V}_{th} ( n )}{{V}_{th} ( n )} \\ 1 \leq n \leq N - 1 \qquad ( 8 )$$

The transistor Tₙ can be an N-channel enhancement type MOSFET. In some embodiments, the transistor Tₙ can be a low power MOSFET, such as a 2N7000 MOSFET. The threshold voltage Vₜₕ is parameterized for 2.5, 3 and 3.5 [V] as guided by the 2N7000 MOSFET datasheet. FIG. 5B illustrates a graph of resistor ratio Wₙ/Bₙ versus section number. FIG. 5B shows a slight ratio increase with higher section number, because the Vₙ value gradually increases for increasing n and thus increasing Iₙ. The graph shows a possible need for fine-tuning the resistor selections for various threshold voltage Vₜₕ values and increasing section number n.

Other circuit designs for LED ladders are disclosed in details in commonly assigned U.S. Patent Application Publication No. 2012-0001558, entitled “Transistor Ladder Network for Driving a Light Emitting Diode Series String,” U.S. patent application Ser. No. 13/024,825, entitled “Current Sensing Transistor Ladder Driver for Light Emitting Diodes,” U.S. Patent Application No. 61/570,995, entitled “Transistor LED Ladder Driver with Current Regulation for Light Emitting Diodes,” which are incorporated herein by reference in entirety.

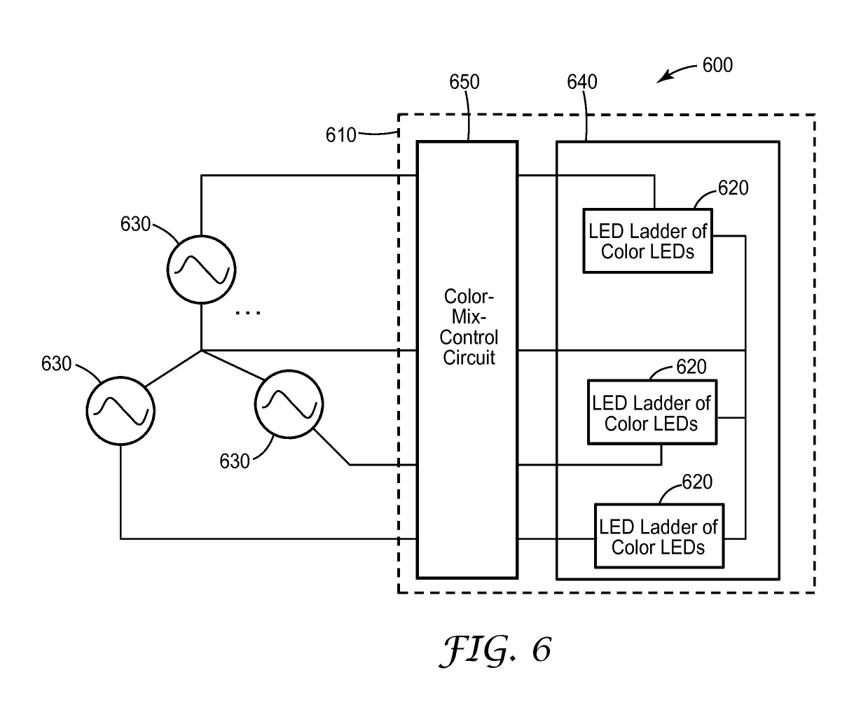

Embodiments of the present disclosure are also directed to colored LED illumination systems with the use of color-mix-control circuits. FIG. 6 illustrates a block diagram of an embodiment of a colored LED illumination system 600. In the illumination system 600, a circuit 610 for producing color controllable illumination from LEDs is coupled to power sources 630 in a polyphase system. The polyphase system has three or more power sources 630 providing alternating currents. The circuit 610 includes a plurality of LED ladders 620 and a color-mix-control circuit 650 coupled to the plurality of LED ladders 620. Each LED ladder 620 includes a plurality of light sections connected in series. Each light section includes one or more color LEDs, and a switch circuit coupled to the LED and configured to activate the LED. The color LEDs in the plurality of LED ladders 620 emit light of different colors. At least two light sections are activated in sequence in response to power supplied from one of the three or more power sources 630. The illumination circuit 610 can optionally include an optical mixing cavity 640, which contains color LEDs in the plurality of LED ladders 620. In some cases, the optical mixing cavity 640 can be implemented with various optical components to provide intra-cavity optical mixing and then produce substantially uniform illumination output. The optical components can include one or more of, for example, such as diffusers, reflectors, transflectors, polarizing films, brightness enhancement films (BEF), or the like. The LED ladder 620 can be implemented by any suitable LED ladder circuit design discussed above.

The color-mix-control circuit 650 is configured to adjust the intensity of each LED ladder to control the output color collectively by the LEDs in the LED ladders 620. In some implementations, the color-mix-control circuit 650 can control which light sections in which LED ladders are active. Thus, the color output can be determined by the color arrangement of LEDs in the activated light sections in the plurality of LED ladders. As the light sections in an LED ladder turn on in sequence, the arrangement of the LEDs determines the output color of the LED ladder with colors 1, 2, . . . n correlated to the color of the LEDs in light sections LS₁, LS₂, . . . LSₙ. The output color is also based upon color mixing optics and optional filtering optics used in the optical mixing cavity 640.

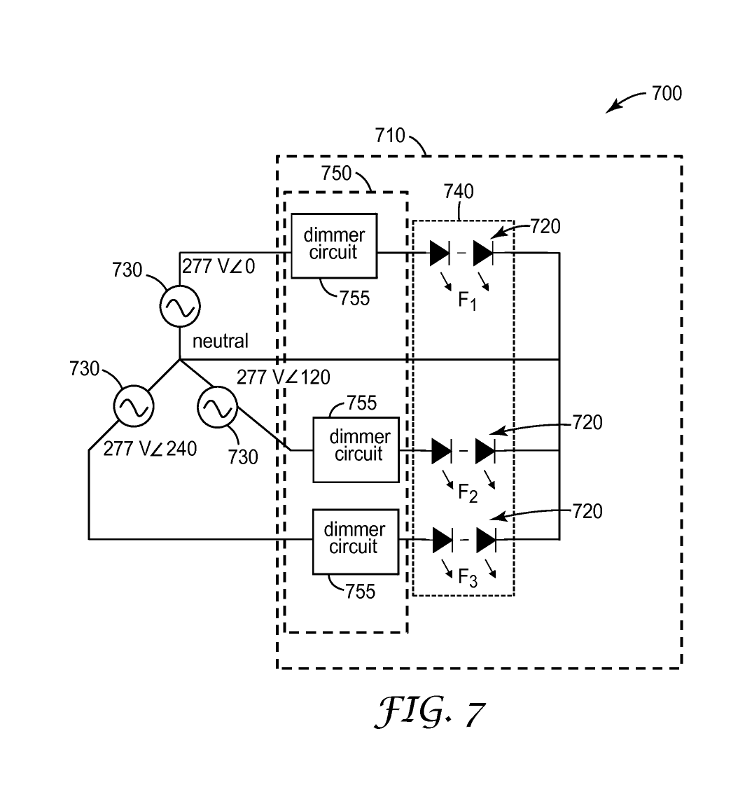

In some embodiments, an LED ladder may include LEDs of a particular color, as illustrated in FIG. 7, where a colored LED illumination circuit 710 is coupled with a three-phase system with three power sources 730 providing alternating currents. In some implementations, the colored LED illumination circuit 710 can be coupled to a polyphase system having three or more power sources. The colored LED illumination circuit 710 includes a plurality of LED ladders 720 and a color-mix-control circuit 750 coupled to the plurality of LED ladders. Each LED ladder 720 includes a plurality of light sections connected in series. Each light section includes one or more LEDs of a particular color, and a switch circuit coupled to the LED and configured to activate the LED. At least two light sections are activated in sequence in response to power supplied from one of the three power sources 730. In some implementations, all light sections in an LED ladder include LEDs of the same particular color. The colored LED illumination circuit 710 can optionally include an optical mixing cavity 740, which contains color LEDs in the plurality of LED ladders 720. The optical mixing cavity 740 can provide intra-cavity optical mixing and substantially uniform illumination output.

In some implementations, the color-mix-control circuit comprises a dimmer circuit 755 for each of the plurality of LED ladders 720. The dimmer circuit 755 is coupled with an LED ladder 720 and configured to control the number of the light sections activated in the LED ladder 720. Thus, the dimmer circuit 755 can control the illumination intensity of the LED ladder 720. In some cases, the colored LED illumination circuit 710 can include three LED ladders 720, where LEDs in the three LED ladders are a tri-color combination such as red, green, and blue respectively. In some implementations, the color-mix-control circuit 750 can include a user interface to allow manual adjustment of intensity of each LED ladder individually to generate a desired color. In some other implementations, the color-mix-control circuit 750 can include a processor to receive a color-code input and automatically control the intensity of each LED ladder individually to generate a desired color. For example, for three LED ladders having red, green, and blue LEDs respectively, the color-mix-control circuit 750 can include a processor to receive a color-code input and automatically control the intensity of the red LED ladder, the blue LED ladder, and the green LED ladder individually to generate a desired color.

In some embodiments, the dimmer circuit 755 includes a TRIAC. In some other embodiments, the dimmer circuit 755 can include one or more phase cutting electronic components, for example, transistors. In yet other embodiments, the dimmer circuit 755 can include an autotransformer to attenuate the voltage supplied to an LED ladder, for example, a variac. In yet other embodiments, the dimmer circuit 755 can include switched-mode power supply (SMPS) electronic components to regulate the voltage supplied to an LED ladder.

LED ladder circuitry can have outstanding power factor performance. FIG. 8 is a graph illustrating power factor performance of an 11 section LED ladder driver with circuitry similar to the circuit design in FIG. 4B. The power factor PF as a special case of a Holder inequality is evaluated using the line voltage V and current I shown in equation (9), with T covering an exact integer number of periods and τ arbitrary:

$$PF = \frac{{\int }_{τ}^{τ + T} V \times I d t}{{TV}_{rm s} {I}_{rm s}} \leq 1 \qquad ( 9 )$$

With the circuitry of the ladder network, power factors of 0.98 or better are easily obtained. For example, the PF value in FIG. 8 is 0.999.

It is also possible to define a single quantity of current total harmonic distortion (THD) to evaluate harmonic performance. Equation (10) defines a THD with the property of 0<THD<1. With I indicating current amplitude and its subscript the harmonic order of the fundamental 60 [Hz] component, the following THD quantity is defined as:

$$THD = \frac{\sqrt{{I}_{2}^{2} + {I}_{3}^{2} + {I}_{4}^{2} + …}}{\sqrt{{I}_{1}^{2} + {I}_{2}^{2} + {I}_{3}^{2} + {I}_{4}^{2} + …}} = \frac{\sqrt{{\sum }_{n = 2}^{∞} {I}_{n}^{2}}}{\sqrt{{\sum }_{n = 1}^{∞} {I}_{n}^{2}}} \qquad ( 10 )$$

Table 1 illustrates International Electrotechnical Commission (IEC) compliance mandated in Europe since 2001.

TABLE 1

| | IEC maximum allowed amplitude |
|---|---|
| | normalized on fundamental for class C |
| harmonic | lighting equipment |
| 2^{nd} | 0.02 |
| 3^{rd} | 0.3 × PF |
| 5^{th} | 0.1 |
| 7^{th} | 0.07 |
| 9^{th} | 0.05 |
| 9 < order < 40 | 0.03 |

In general, when THD<0.1, Table 1 compliance is obtained and the THD can be a meaningful guide for current harmonic performance. For a perfectly harmonic voltage V in equation (9), it can be shown that PF in equation (9) and THD in equation (10) are related by:

$$THD = \sqrt{1 - \frac{{PF}^{2}}{{cos}^{2} {ϕ}_{1}}} \qquad ( 11 )$$

where φ₁ is the phase angle between voltage and fundamental current component. In well designed cases, φ₁ is typically close to zero degrees, so the squares of THD and PF appear complementary:

THD²+PF²≈1 (12)

FIG. 9 is a graph illustrating a current spectrum of a LED ladder driver having harmonic distortion within the IEC limits. The spectrum in FIG. 9 is computed based upon the discrete samples of exactly one period of the LED current waveform in FIG. 8. The spectrum is generated by adding j times the Hilbert transform of the waveform with j²=−1. This is spectrally equivalent to filtering out all negative frequency components and multiplying the positive frequency components by 2. With such computation, the spectral amplitude in FIG. 9 is easily reconciled with the current amplitude in FIG. 8. The THD value of the spectrum in FIG. 9 is 5.1%.

The components of LED ladders, with or without the LEDs, can be implemented in an integrated circuit. Leads connecting the LED sections enable the use as a driver in solid state lighting devices. Examples of solid state lighting devices are described in U.S. patent application Ser. No. 12/535,203 and filed on Aug. 4, 2009, U.S. patent application Ser. No. 12/960,642 and filed on Dec. 6, 2010, and U.S. patent application Ser. No. 13/019,498 and filed on Feb. 2, 2011, all of which are incorporated herein by reference as if fully set forth.

What is claimed is:

1. A circuit for producing generally constant illumination from light emitting diodes (LEDs) in a polyphase system having three or more power sources providing alternating currents, the circuit comprising:
three or more LED ladders, each LED ladder coupled to one of the three or more power sources on a one-to-one basis, the three or more power sources collectively providing a substantially constant electrical power, each LED ladder comprising:
a plurality of light sections connected in series, wherein each light section comprises:
an LED, and
a switch circuit coupled to the LED and configured to activate the LED,
wherein at least two light sections are activated in sequence in response to power supplied from the one of three or more power sources.

2. The circuit of claim 1, wherein at least one of the three or more LED ladders further comprises:
a current regulating circuit coupled to the plurality of light sections,
wherein the current regulating circuit is configured to limit a LED current flowing through the plurality of light sections based upon the number of activated light sections.

3. The circuit of claim 1, wherein each light section further comprises a resistive element, wherein the resistance of the resistive element is a function of the peak line current of the circuit and the section number.

4. The circuit of claim 2, wherein the current regulating circuit comprises a transistor.

5. The circuit of claim 1, wherein the switch circuit comprises a transistor.

6. The circuit of claim 5, wherein the switch circuit further comprises a resistive element.

7. The circuit of claim 5, wherein the switch circuit further comprises a variable resistive element.

8. The circuit of claim 1, wherein the polyphase system has three power sources, each of the three power sources has a 120 degrees phase shift from the other power sources.

9. The circuit of claim 1, wherein at least one of the three or more LED ladders further comprises a rectifier coupled between the light sections and the one of the three or more power sources.

10. The circuit of claim 9, wherein the at least one of the three or more LED ladders further comprises a dimmer circuit coupled to the rectifier, the dimmer circuit is configured to control the number of the light sections activated in sequence.

11. The circuit of claim 10, wherein the dimmer circuit comprises at least one of a TRIAC, a phase cutting electronic component, an autotransformer, and a switched-mode power supply electronic component.

12. The circuit of claim 1, further comprising an optical mixing cavity containing LEDs in the three or more LED ladders.

13. A circuit for controlling an output color of a light emitting diode (LED) illumination system coupled to a polyphase system having three or more power sources providing alternating currents, the circuit comprising:
a plurality of LED ladders, each LED ladder coupled to one of the three or more power sources, each LED ladder comprising:
a plurality of light sections connected in series, wherein each light section comprises:
a color LED, and
a switch circuit coupled to the color LED and configured to activate the color LED,
wherein at least two light sections are activated in sequence in response to power supplied from the one of the three or more power sources,
wherein color LEDs in the plurality of LED ladders emit light of different colors; and
a color-mix-control circuit coupled to the plurality of LED ladders and configured to adjust the intensity of each LED ladder to control an output color of the plurality of LED ladders.

14. The circuit of claim 13, wherein the color-control circuit comprises a dimmer circuit for each LED ladder, wherein the dimmer circuit is configured to control the number of the light sections activated in sequence.

15. The circuit of claim 14, wherein the dimmer circuit comprises at least one of a TRIAC, a phase cutting electronic component, an autotransformer, and a switched-mode power supply electronic component.

16. The circuit of claim 13, wherein at least one of the plurality of LED ladders further comprises:
a current regulating circuit coupled to the plurality of light sections,
wherein the current regulating circuit is configured to limit a LED current flowing through the plurality of light sections based upon the number of activated light sections.

17. The circuit of claim 16, wherein the current regulating circuit comprises a transistor.

18. The circuit of claim 13, wherein each light section further comprises a resistive element, wherein the resistance of the resistive element is a function of the peak line current of the circuit and the section number.

19. The circuit of claim 13, wherein the switch circuit comprises a transistor.

20. The circuit of claim 19, wherein the switch circuit further comprises at least one of a resistive element and a variable resistive element.

21. The circuit of claim 13, further comprising an optical mixing cavity containing color LEDs in the plurality of LED ladders.
